(19) United States
(12) Patent Application Publication
(10) Pub. No.: US 2025/0297084 A1
(43) Pub. Date: Sep. 25, 2025

(54) FOAMABLE COMPOSITION AND FOAM ARTICLE MADE THEREFROM

(71) Applicants: Dow Global Technologies LLC, Midland, MI (US); Rohm and Haas Company, Collegeville, PA (US)

(72) Inventors: Fernanda Bortolane Bueno, Sao Paulo (BR); Jinliang Yan, Shanghai (CN); Colin Li Pi Shan, Pearland, TX (US); Jorge Caminero Gomes, Sao Paulo (BR); Juan Carlos Casarrubias, Mexico City (MX)

(21) Appl. No.: 18/863,864

(22) PCT Filed: Jul. 27, 2022
(86) PCT No.: PCT/CN2022/108126

§ 371 Date: Nov. 7, 2024

(51) Int. Cl. C08L 23/0807; C08J 9/10; C08K 3/22; C08K 3/26; C08K 5/098; C08K 5/14

(52) U.S. Cl. CPC C08L 23/0815; C08J 9/103; C08K 3/26; C08K 5/098; C08K 5/14; C08J 2203/184; C08J 2323/08; C08J 2423/08; C08J 2453/00; C08K 2003/2241; C08K 2003/2296; C08K 2003/265; C08L 2203/14; C08L 2205/03

(57) ABSTRACT

A foamable composition including: (a) at least one elastomer selected from the group consisting of: (i) ethylene/alpha-olefin multi-block interpolymers, (ii) ethylene/alpha-olefin elastomers, and (iii) combinations thereof; (b) at least one ethylene vinyl acetate; (c) at least one polarity modifier selected from the group consisting of: (i) ethylene-alkyl acrylate copolymers, (ii) ethylene-alkyl methacrylate copolymers, and (iii) combinations thereof; (d) at least one crosslinking agent; and (e) at least one blowing agent.

### FIELD

The present invention relates to a foamable composition for fabricating foam articles and foam articles prepared using the foamable composition. For example, the present invention foamable composition can be used for fabricating foam articles such as shoe parts.

### BACKGROUND

Polyolefin elastomers such as random ethylene-alpha-olefin copolymers and olefin block copolymers have achieved relevant participation in footwear applications such as athletic shoes midsoles, casual shoes soles, insoles, or mono-block shoes (i.e., whole shoes made of a single compound).

The aforementioned polyolefin elastomers are used in compositions or formulations containing ethylene vinyl acetate (EVA) to modify the EVA and to improve many mechanical properties of the composition, such as resilience, lightweight, shrinkage, compression set and hardness. The level of elastomer in the formulation used to manufacture shoe parts varies according to the shoe part and type of shoe. The level of elastomer in the formulation can vary, for example, from 10 phr to 90 phr. “High value-added shoes” typically contain at least 50 phr of elastomers. However, the higher the level of elastomer (which is a non-polar material) used in the formulation to make a shoe part, the more difficult it is to bond that shoe part to other parts of the shoe made of different materials such as polyvinyl chloride (PVC) (which is a polar material).

The poor bond strength problem has been observed when trying to bond non-polar foams made of EVA and an elastomer (e.g., a polyolefin elastomer (POE) and/or an olefin block copolymer (OBC) to other polar substrates such as PVC at elastomer levels of, for example, ≥50 phr. This problem of poor bonding has occurred for decades. In an attempt to solve the problem heretofore, special primers have been used, especially in Asia, with the objective to improve the bond strength between non-polar and polar substrates. However, the known primers are not always available in, for instance, Latin America countries such as Brazil; and when the known primers are available, the primers can be very expensive. Therefore, there is a need to develop a formulation in which high-pressure copolymer (HPC) materials, that are polar, could be added to the formulation to increase the polarity of the compounds. Consequently, a foam product produced with a formulation having compounds with increased polarity could have an improved bonding performance even when using standard, commercially available primers.

Many footwear manufacturers, such as shoe manufacturers, are willing to add more than 50 phr of elastomers in the shoe manufacturers' formulations because of the shoe manufacturers' technical requirements. However, the shoe manufacturers avoid adding higher levels of elastomers to the shoe manufacturers' formulations because, when the shoe manufacturers try to add more than 50 phr of elastomers in the shoe manufacturers' formulations, the shoe manufacturers' formulations exhibit poor bonding performance. When new footwear such as a new shoe model is desired to be introduced into the market by a shoe manufacturer, if the new shoe exhibits poor bonding in any of the parts making up the new shoe, it can make it impossible for the shoe manufacturer to launch such a new shoe model to the market.

Various methods to improve bonding performance of EVA foams containing elastomers have heretofore been tried with limited to no success; including, for example, the use of: (1) a special primer (NanPao, in Asia, is one supplier of such primer—however, not available in Latin America) applied to the foam as aforementioned; (2) ≥40 wt % of VA (vinyl-acetate) in combination with EVA (ethylene vinyl-acetate) to improve the polarity of the EVA compound and consequently the bonding performance of the formulation; (3) additional steps for foam preparation such as sanding the surface of the foam prior to applying a primer to the surface of the foam; and (4) a special adhesive applied to the foam. However, the use of the above-described methods still leads to poor bonding performance of the formulation.

For example, CN1997693B (equivalent to U.S. Patent Application Publication 2005/0288442) discloses a composition that includes: (i) 50 wt % to 95 wt %, preferably 70 wt % to 90 wt %, of an ethylene-acrylate copolymer, (ii) 5 wt % to 50 wt %, preferably 10 wt % to 30 wt %, of an acid copolymer or ionomer or the acid copolymer, and (iii) 0 wt % to 40 wt % of a soft ethylene polymer. The foam composition described in the above reference improves crosslinking and mechanical properties while retaining the inherent merits of the ethylene-methyl acrylate copolymer. However, the above reference does not disclose any improvement related to the bonding performance of the foam formulation containing an ethylene-acrylate copolymer, an acid copolymer or ionomer, and an ethylene polymer. And, although the above reference mentions the use of an ethylene-methyl acrylate, the formulation does not include a combination of ethylene-methyl acrylate, EVA, and elastomer.

Other references disclose foam compositions, foam layers, and/or foam articles including, for example, WO2017/156674A1; IN202017000715A (equivalent to WO2019/000155A1); and CN103304882A (equivalent to WO2013/134354). However, none of the above-mentioned references disclose the use of a copolymer of ethylene and methyl (or butyl) acrylate to improve the polarity of the foam material and/or a foamable formulation containing a copolymer of ethylene and methyl (or butyl) acrylate in combination with EVA and at least 50 phr elastomer (POEs and/or OBCs) with the objective of improving bonding performance.

It would, therefore, be desirous to provide a foamable composition including a copolymer of ethylene and methyl (or butyl) acrylate in combination with EVA and at least 50 phr elastomer (POEs and/or OBCs); wherein the foamable composition can be used for fabricating a foam article; and wherein the foam article exhibits improved bonding performance.

### SUMMARY

The foamable composition of the present invention solves the problem of poor bonding encountered by prior art formulations. The present invention foamable formulation includes EVA; at least one elastomer (e.g., a POE and/or an OBC) at a concentration of at least 50 phr; and at least one copolymer of ethylene and an acrylate such as a copolymer of ethylene and methyl acrylate or a copolymer of ethylene and butyl acrylate in a concentration level that can vary from 10 phr to 40 phr depending on the total components in the formulation. The foamable composition of the present invention can also include one or more other raw material components such as crosslinking agents, blowing agents, activators, and nucleating agents.

One general embodiment of the present invention is directed to a foamable composition including HPC materials added to a formulation containing EVA and elastomers. For example, the HPC materials can include ethylene and methyl (or butyl) acrylate copolymers which can be added to the formulation of EVA and elastomers. The elastomers can be present in the formulation at ≥50 phr. The addition of the HPC materials improve the polarity of the resultant foam composition and leads to an improved bonding of the resultant foam to other substrates such as PVC.

Another general embodiment of the present invention is directed to a foamable composition or formulation for use in producing a foam article; wherein the foamable composition includes: (a) one or more elastomers selected from the group consisting of: (i) ethylene/alpha-olefin multi-block interpolymers having a density of from 0.850 g/cc to 0.890 g/cc in one general embodiment and a melt index (I₂) of from 0.5 g/10 min to 50 g/10 min in one general embodiment, (ii) ethylene/alpha-olefin elastomers having a density of from 0.850 g/cc to 0.890 g/cc in one general embodiment and a I₂ of from 0.5 g/10 min to 50 g/10 min in one general embodiment, and (iii) combinations thereof, wherein the concentration of the elastomer is ≥45 wt %, based on the foamable composition; (b) at least one EVA, wherein the concentration of the EVA is ≥5 wt %, based on the foamable composition; (c) one or more polarity modifiers selected from the group consisting of: (i) ethylene-alkyl acrylate copolymers, (ii) ethylene-alkyl methacrylate copolymers; and (iii) combinations thereof, wherein the concentration of the polarity modifier is in the range of from 5 wt % to 50 wt %, based on the foamable composition; (d) one or more crosslinking agents, wherein the concentration of the crosslinking agent is ≥1 wt %, based on the foamable composition; and (e) one or more blowing agents, wherein the concentration of the blowing agent is ≥1 wt %, based on the foamable composition.

In still another general embodiment, the present invention is directed to a foamable composition that advantageously includes the use of a curable primer wherein the curable primer is not required to be UV-cured.

In addition, the foamable composition of the present invention include ≥50 phr of elastomers without detrimentally affecting the bonding capability of the foam article made from the foamable composition when the foam article is bonded to other different materials.

In yet another embodiment, the present invention is directed to a foam article, such as a shoe part, made from the above foamable composition.

In other embodiments, the present invention is directed to processes for preparing the above foamable composition and the above foam article.

The present invention is advantageous because making a foam using a foamable composition of the present invention containing a copolymer of ethylene and an acrylate (e.g., a methyl acrylate or a butyl acrylate), in formulations of EVA with at least 50 phr elastomer (POEs and/or OBCs), the minimum bond strength required for a satisfactory bonding performance of the foam when bonding the foam to a polar substrate such as flexible PVC, is achieved while maintaining satisfactory results of the foam's mechanical properties, for example, density, shrinkage, rebound and hardness. The present invention provides a foamable composition that uses at least 50 phr of elastomers such as olefin block copolymers; and still the resultant foamable composition can provide a foam article having improved bonding performance.

### BRIEF DESCRIPTION OF THE DRAWINGS

FIG. 1 is a schematic cross-sectional view of a multi-layer foam structure useful for bonding strength testing showing the various layers of the structure.

FIG. 2 is an image showing a top perspective view of three separate present invention specimens of multi-layer foam structures having the multi-layer structure shown in FIG. 1, after the three present invention specimens have been subjected to bond strength testing resulting in the two separate torn specimen pieces shown in FIG. 2 for each of the three specimens tested.

FIG. 3 is an image showing a top perspective view of three separate comparative specimens of multi-layer foam structures having the multi-layer structure shown in FIG. 1, after the three comparative specimens have been subjected to bond strength testing resulting in the two separate untorn specimen pieces shown in FIG. 3 for each of the specimens tested.

### DETAILED DESCRIPTION

Reference will now be made in detail to embodiments of a foamable composition and to a foam article made from the foamable composition wherein the foamable composition, in a broad embodiment, includes (a) at least one elastomer; (b) at least one ethylene vinyl acetate; (c) at least one polarity modifier; (d) at least one crosslinking agent; and (e) at least one blowing agent. Optionally, other compounds can be added to the composition such as accelerators and fillers, if desired.

The foams produced from the foamable composition may be used, for example, in footwear applications such as in the manufacture of shoe parts; however, it is noted that this application is merely an exemplary and illustrative implementation of the embodiments disclosed herein. The embodiments are applicable to other technologies that desire bonding a foam material to other different substrate materials while maintaining the foam material's other mechanical properties.

The term “composition” (which is used herein interchangeably with the term “formulation”) refers to a mixture of materials that comprises the composition, as well as reaction products and decomposition products formed from the materials of the composition.

The term “elastomer” refers to a polymer with viscoelasticity (having both viscosity and elasticity) and very weak inter-molecular forces, generally having low Young's modulus and high failure strain compared with other materials. An elastomer has the property of elasticity, i.e., the elastomer is a polymer that deforms under stress and returns to its original shape when the stress is removed, having long flexible chain-like molecules with high mobility above its Tg (glass transition temperature).

As used herein, the term “polymer” refers to a polymeric compound prepared by polymerizing monomers, whether of the same or a different type. The generic term “polymer” thus embraces: (1) the term homopolymer (employed to refer to polymers prepared by polymerizing only one type of monomer, with the understanding that trace amounts of impurities can be incorporated into the polymer structure); and (2) the term copolymer or interpolymer (employed to refer to polymers prepared by polymerizing two or more different monomers, with the understanding that trace amounts of impurities can be incorporated into the polymer structure). Trace amounts of impurities (for example, catalyst residues) may be incorporated into and/or within the polymer. A polymer may be a single polymer or a polymer blend.

The term “interpolymer” refers to polymers prepared by polymerizing at least two different types of monomers. The generic term interpolymer thus includes copolymers and other polymers prepared by polymerizing more than two different monomers, such as terpolymers.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used throughout this specification, the abbreviations given below have the following meanings, unless the context clearly indicates otherwise: “=” means “equal to”; “@” means “at”; “˜” means “approximately”; “<” means “less than”; “≤” means “less than or equal to”; “>” means “greater than”; “≥” means “greater than or equal to”; “I₂” means “melt index”; g=gram(s); mg=milligram(s); phr=parts per hundred of resin; kg=kilogram(s); g/cc=gram(s) per cubic centimeter; kg/m³=kilogram(s) per cubic meter; g/mol=gram(s) per mole; L=liter(s); mL=milliliter(s); g/L=gram(s) per liter; Mw=Mass molecular weight; Mn=number molecular weight; Mz=z-average molecular weight; m=meter(s); mm=millimeter(s); cm=centimeter(s); min=minute(s); s=second(s); hr=hour(s); mPa=megapascal(s); MPa=Megapascal(s); N=newton(s); mm²=millimeter(s) squared; g/10 min=gram(s) per 10 minutes; %=percent; wt %=weight percent; cpm=cycles per minute; and N/mm=Newton per millimeter.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” or “room temperature” means between 20° C. and 25° C., unless specified otherwise.

In a broad embodiment, the present invention relates to a foamable formulation or composition useful for producing a foam product or foam article, the composition comprising, for example, a combination, blend or mixture of: (a) at least one elastomer selected from the group consisting of: (i) ethylene/alpha-olefin multi-block interpolymers; (ii) ethylene/alpha-olefin elastomers; and (iii) combinations thereof; (b) at least one ethylene vinyl acetate; (c) at least one polarity modifier selected from the group consisting of: (i) ethylene-alkyl acrylate copolymers, (ii) ethylene-alkyl methacrylate copolymers; and (iii) combinations thereof; (d) at least one crosslinking agent; and (e) at least one blowing agent.

In some embodiments, the above composition is advantageously used to make a foam product or foam article used in footwear applications. In one embodiment, the foam product or foam article is a shoe part that is bonded to one or more other different parts of the shoe.

In some embodiments, the foam composition comprises, for example:
(a) from 45 wt % to 100 wt %, based on the foamable composition, of one or more elastomers selected from the group consisting of: (i) ethylene/alpha-olefin multi-block interpolymers having a density of 0.850 g/cc to 0.890 g/cc and a I₂ of 0.5 g/10 min to 50 g/10 mm; (ii) ethylene/alpha-olefin elastomers having a density of 0.850 g/cc to 0.890 g/cc and a I₂ of 0.5 g/10 min to 50 g/10 min; and (iii) combinations thereof;
(b) from 5 wt % to 35 wt %, based on the foamable composition, of one or more ethylene vinyl acetates;
(c) from 10 wt % to 40 wt %, based on the foamable composition, of one or more polarity modifiers selected from the group consisting of: (i) ethylene-alkyl acrylate copolymers, (ii) ethylene-alkyl methacrylate copolymers; and (iii) combinations thereof;
(d) from 1 wt % to 3 wt %, based on the foamable composition, of one or more crosslinking agents; and
(e) from 1 wt % to 3 wt %, based on the foamable composition, of one or more blowing agents.

Optionally, the composition may also include a component (f) of one or more additives, if desired.

In one preferred embodiment, the foam composition comprises, for example: (a) an elastomer (at least 50 phr) including an olefin block copolymer (e.g., INFUSE™, a product available from The Dow Chemical Company) and/or a polyolefin elastomer (e.g., ENGAGE™, a product available from The Dow Chemical Company); (b) EVA (e.g., ELVAX™, a product available from The Dow Chemical Company); (c) ethylene-methyl acrylate (e.g., ELVALOY™ AC, a product available from The Dow Chemical Company) at a concentration of from 10 phr to 40 phr; (d) a crosslinking agent such as peroxide, which is at least 99% pure; and (e) a blowing agent such as azodicarbonamide. The foam composition may include one or more optional additives, for example, an accelerator (e.g., ZnO and/or ZnSt); and fillers (e.g., CaCO₃ and/or TiO₂).

The expansion ratio of the foam composition is from 1.5 to 1.6 in one general embodiment.

In one general embodiment of the present invention, the foamable composition useful for preparing the foam article includes, for example, at least one elastomer. Exemplary of the elastomer, component (a), useful for preparing the foamable composition of the present invention includes polyolefin elastomers (POEs), olefin block copolymers (OBCs), and mixtures thereof. In a preferred embodiment, the elastomer includes, olefin block copolymers (OBCs) and mixtures of OBC with other polyolefin polymers.

Exemplary of some commercial elastomers useful for preparing the foamable composition of the present invention includes for example: INFUSE™ OBC 9500 (available from The Dow Chemical Company); Tafmer DF740 (available from Mitsui company); and mixtures thereof.

In some embodiments, the elastomer useful in the present invention includes elastomers having a density of from 0.850 g/cc to 0.890 g/cc in one general embodiment; from 0.850 g/cc to 0.880 g/cc in another embodiment; and from 0.850 g/cc to 0.870 g/cc in still another embodiment. In some embodiments, the elastomer useful in the present invention includes elastomers having a I₂ of from 0.5 g/10 min to 50 g/10 min in one general embodiment; from 0.5 g/10 min to 30 g/10 min in another embodiment; and from 1 g/10 min to 30 g/10 min in still another embodiment.

The elastomer, used in preparing the foamable composition, can be present in the foamable composition in an amount of from 45 wt % to 100 wt % in one general embodiment; from 45 wt % to 90 wt % in another embodiment; and from 45 wt % to 70 wt % in still another embodiment, based on the total amount of components in the foamable composition.

In one general embodiment of the present invention, the foamable composition useful for preparing the foam article includes, for example, at least one ethylene vinyl acetate (EVA). Exemplary of the EVA, component (b), useful for preparing the foamable composition of the present invention includes various grades of EVA such as, for example, EVA having a level of vinyl acetate (VA) of from 18 wt % VA to 35 wt % VA in one general embodiment; EVA having a level of VA of from 18 wt % VA to 32 wt % VA in another embodiment; EVA having a level of VA of from 18 wt % VA to 28 wt % in still another embodiment; and mixtures thereof.

Exemplary of some commercial EVA compounds useful for preparing the foamable composition of the present invention includes for example: ELVAX™ 460 (available from The Dow Chemical Company); EVA 3019PE (available from Braskem Company); and mixtures thereof.

The EVA, used in preparing the foamable composition, can be present in the foamable composition in an amount of from 5 wt % to 35 wt % in one general embodiment; and from 10 wt % to 35 wt % in another embodiment in still another embodiment, based on the total amount of components in the foamable composition.

In one general embodiment of the present invention, the foamable composition useful for preparing the foam article includes, for example, at least one at least one polarity modifier. Exemplary of the polarity modifier, component (c), useful for preparing the foamable composition of the present invention includes for example, at least one or more copolymers of ethylene and a (meth)acrylate. A “(meth)acrylate” herein means an acrylate and/or a methacrylate. For example, in some embodiments, the (meth)acrylate can include methyl acrylate, methyl methacrylate, ethyl acrylate, butyl acrylate, butyl methacrylate, and mixtures thereof. In some embodiments, the copolymer of the present invention comprises an ethylene-(meth)acrylate which can include, for example, ethylene-methyl acrylate; ethylene-butyl acrylate; and mixtures thereof. In a preferred embodiment, the polarity modifier includes, for example, ethylene-methyl acrylate; and mixtures of ethylene-methyl acrylate with other acrylates.

Exemplary of some commercial polarity modifier compounds useful for preparing the foamable composition of the present invention includes for example, ELVALOY™ AC acrylate copolymers (available from The Dow Chemical Company); and mixtures of the ELVALOY™ AC acrylate copolymers with other conventional acrylate copolymers.

The polarity modifier, used in preparing the foamable composition, can be present in the foamable composition in an amount of from 5 wt % to 50 wt % in one general embodiment; from 10 wt % to 40 wt % in another embodiment; from 10 wt % to 30 wt % in still another embodiment; and from 10 wt % to 20 wt % in yet another embodiment, based on the total amount of components in the foamable composition.

In one general embodiment of the present invention, the foamable composition useful for preparing the foam article includes, for example, at least one at least one crosslinking agent.

Exemplary of the crosslinking agent, component (d), useful for preparing the foamable composition of the present invention includes for example, dicumyl peroxide; and mixtures of dicumyl peroxide with other crosslinking agents.

Exemplary of some commercial crosslinking agent compounds useful for preparing the foamable composition of the present invention includes for example: Luperox DC40P-SP2 (available from Arkema); Luperox 101 (available from Arkema); and mixtures thereof.

The crosslinking agent, used in preparing the foamable composition, can be present in the foamable composition in a concentration of ≥1 wt % in one general embodiment; and from 1 wt % to 3 wt % in another embodiment, based on the total amount of components in the foamable composition.

In one general embodiment of the present invention, the foamable composition useful for preparing the foam article includes, for example, at least one foam-generating agent. The foam-generating agent can include, for example, a blowing agent admixed into the foamable formulation, a foam-generating material such as a gaseous material or substance added to the foamable composition by physical means such as by blowing equipment known to those skilled in the art of forming a foam; or mixtures thereof. A “blowing agent” is a substance that is capable of producing a cellular structure in a foamable composition via a foaming process. The blowing agent is used for foaming dynamically crosslinked polymers. The blowing agent used in the present invention is not particularly limited, so long as the blowing agent can expand the crosslinked particles.

Exemplary of the blowing agents suitable for making the foams of the present invention can include, but are not limited to, (I) inorganic blowing agents, (II) organic blowing agents, (III) chemical blowing agents, and (IV) combinations thereof. Some blowing agents useful in the present invention are disclosed, for example, in Sendijarevic et al., “Polymeric Foams And Foam U.S. Pat. No. 7,666,918 B2 25 Technology,” Hanser Gardner Publications, Cincinnati, Ohio, 2nd edition, Chapter 18, pages 505-547 (2004).

Non-limiting examples of suitable inorganic physical blowing agents, component (I), useful in the present invention include carbon dioxide, nitrogen, argon, water, air, helium, oxygen, neon, and mixtures thereof.

Non-limiting examples of suitable organic physical blowing agents, component (II), useful in the present invention include: (1) aliphatic hydrocarbons having 1-6 carbon atoms, such as methane, ethane, propane, n-butane, isobutane, n-pentane, isopentane, neopentane, n-hexane, and mixtures thereof; (2) aliphatic alcohols having 1-3 carbon atoms, such as methanol, ethanol, n-propanol, isopropanol, and mixtures thereof; (3) alicyclic hydrocarbons, such as cyclohexane, cyclopentane, and mixtures thereof; and (4) fully and partially halogenated aliphatic hydrocarbons having 1-4 carbon atoms, such as (i) fluorocarbons, (ii) chlorocarbons, (iii) chlorofluorocarbons, and (iv) mixtures thereof.

Non-limiting examples of suitable fluorocarbons, component (4)(i), useful in the present invention include methyl fluoride; perfluoromethane; ethyl fluoride; 1,1-difluoroethane (HFC152a); 1,1,1-trifluoroethane (HFC-143a); 1,1,1,2-tetrafluoroethane (HFC-134a); pentafluoroethane; difluoromethane; perfluoroethane; 2,2-difluoropropane; 1,1,1-trifluoropropane; perfluoropropane; 1,1-difluoropropane; perfluorobutane; perfluorocyclobutane; chlorofluoromethane; trifluoromethane; and mixtures thereof.

Non-limiting examples of suitable partially halogenated chlorocarbons, component (4)(ii) and chlorofluorocarbons, component (4)(iii), useful in the present invention include dialkyl ethers such as, dimethyl ether, diethyl ether, methyl ethyl ether, and mixtures thereof; methyl chloride; methylene chloride; ethyl chloride; 1,1,1-trichloroethane; 1,1-dichloro-1-fluoroethane (HCFC-141b); 1-chloro-1,1-difluoroethane (HCFC-142b); 1,1-dichloro-2,2,2-trifluoroethane (HCFC-123); 1-chloro-1,2,2,2-tetrafluoroethane(HCFC-124); dichloropropane and mixtures thereof.

Non-limiting examples of suitable fully halogenated chlorofluorocarbons, component (4)(iii), useful in the present invention include trichloromonofluoromethane (OPOI 1); dichlorodifluoromethane (CFO-12); trichlorotrifluoroethane (CFO-113); dichlorotetrafluoroethane (CFO-114); chloroheptafluoropropane; dichlorohexafluoropropane; and mixtures thereof.

Non-limiting examples of suitable chemical blowing agents, component (III), useful in the present invention include azodicarbonamide; azodiisobutyro-nitrile; benezenesulfonhydrazide; 4,4-oxybenzene sulfonyl-semicarbazide; p-toluene sulfonyl semi-carbazide; barium azodicarboxylate; N,N′-dimethyl-N,N′-dinitrosoterephthalamide; trihydrazino triazine; and mixtures thereof.

Any of the blowing agents described above may be used alone or as a combination of two or more kinds thereof. In one preferred embodiment, the blowing agent used in the present invention is at least one of the inorganic physical blowing agents since inorganic physical blowing agents are not known to deplete the ozone layer and are relatively inexpensive. In some embodiments, the inorganic physical blowing agent used is one or more blowing agents selected from the group consisting of nitrogen, air, carbon dioxide (CO₂), and mixtures thereof. In some embodiments, the crosslinking and foaming steps described above are performed as a series of steps in different vessels.

In other embodiments, the blowing agent useful in the present invention is selected from the group consisting of azodicarbonamide, isobutane, CO₂, or a mixture thereof. In one preferred embodiment, the blowing agent, component (e), useful for preparing the foamable composition of the present invention includes, for example, azodicarbonamide; and mixtures of azodicarbonamide and any one or more of the other aforementioned blowing agents.

Exemplary of some commercial blowing agent compounds useful for preparing the foamable composition of the present invention includes, for example, Celogen AZ130 (available from Lion Copolymer); Unicell D300 (available from DONGJIN SEMICHEM CO., LTD.); and mixtures thereof.

In one preferred embodiment, a blowing agent is used to prepare the foamable composition; and the blowing agent can be present in the foamable composition in a concentration of ≥1 wt % in one general embodiment; and from 1 wt % to 3 wt % in another embodiment, based on the total amount of components in the foamable composition.

In some embodiments, the foamable composition of the present invention can include a wide variety of other optional additives. The additives in combination with the composition of the present invention may be formulated to enable performance of specific functions while maintaining the excellent benefits/properties of the composition. For example, the following additives may be blended into the formulated resin composition to form the foamable composition of the present invention including: accelerators such as zinc oxide (ZnO) and/or zinc stearate (ZnSt); fillers such as calcium carbonate (CaCO₃); nucleating agents; antioxidants; pigments; colorants such as titanium oxide (TiO₂) to provide a white color; UV stabilizers; UV absorbers; processing aids; compatibilizers; other polymer resins; and the like; and mixtures thereof.

The optional additive, when used in the foamable composition, may be added to the foamable composition in an amount of ≤10 wt % in one general embodiment; ≤5 wt % in another embodiment; ≤3 wt % in still another embodiment, and ≤1 wt % in yet another embodiment, based on the total amount of components in the foamable composition. In other embodiments, the optional additive may be added to the foamable composition in an amount of from 0 wt % to 10 wt % in one general embodiment; from 0.05 wt % to 5 wt % in another embodiment; from 0.1 wt % to 5 wt % in still another embodiment; from 1 wt % to 5 wt % in yet another embodiment and from 1 wt % to 3 wt % in even still another embodiment, based on the total amount of components in the foamable composition.

In one broad embodiment of the present invention, a process for making the foamable composition includes, for example, mixing or blending components (a) to (e) described above; and any desired optional component (f) as described above. The processes and equipment used for mixing the components are well known to those skilled in the art of mixing. For example, the mixing process to produce the foam products can include an injection molding process or a bun foam process. In one preferred embodiment, the bun foam process is used; and this type of mixing process in general includes the following general procedure:

All ingredients of the foamable composition are weighed and added to an internal mixer. The rotor speed of the internal mixer is maintained at a rate that allows mixing of the ingredients without creating excessive shear heating which can prematurely activate the peroxide or blowing agent components in the foamable composition. In one general embodiment, rotations per minute (rpm) in the range of between 75 rpm to 100 rpm is used to initially melt the polymer which is first added to the mixer alone. Then, the rpm of the mixer is lowered to ˜50 rpm; and the remaining ingredients are added to the mixer. The rpm and time of mixing the ingredients will depend on the batch (i.e., the mixture of ingredients in the mixer) temperature. For example, in one general embodiment, the rotor speed of the internal mixer is adjusted to maintain the batch temperature in the range of between 120° C. and 130° C. In other embodiments, a slow rotor speed may require additional mixing time of the ingredients in the mixer to complete the batch. For example, the time of mixing the batch at the above-described rotor speeds can run from 10 min to 15 min in one general embodiment.

Once all the ingredients have been added to the mixer and thoroughly mixed, the batch is dropped from the mixer into a catch pan with a non-stick liner (e.g., a polyethylene terephthalate [PET] film). The batch in the catch pan is then quickly transferred to a roll mill station where the batch is placed into a heated roll mill. The roll mill is typically heated (e.g., from 90° C. to 105° C.) to keep the batch from solidifying during the finishing step of the batch; and to allow further mixing of any ingredients that may have transferred to the surface of the batch while exiting the internal mixer.

In some embodiments, the batch can be passed once through the roll mill; and in other embodiments, the batch can be passed once through the roll mill, folded, and then re-passed through the roll mill 3 or 4 times to help disperse any ingredients that remain on the surface of the batch. Cooling the batch below the polymer solidification point (Tc) is to be avoided because if the batch cools below Tc, that will cause the surface of the resulting formed “sheet” to become uneven. After from 1 min to 2 min of rolling a sample batch through the roll mill to form the sheet, the sheet is removed from the roll mill and cooled to 20° C. in preparation of foam molding.

In some embodiments, the thickness of the sheet is sufficient to fill a molding chase by stacking one to three sheets in the molding chase. By minimizing the number of sheets stacked in the molding chase, the potential to create voids between the layers of sheets will be reduced. In one preferred embodiment, a sample sheet stacked in the molding chase is sandwiched in between two layers of release film. Then, the sample is disposed in between two platens of the molding chase. The two platens are closed and the sample compressed.

Some of the advantageous/beneficial properties exhibited by the foamable composition produced according to the aforementioned mixing processes, can include, for example: the foamable composition can be easily produced, that is, the different components (a)-(e), and optionally (e) of the foamable composition can be dispersed easily and more evenly (uniformly or homogeneously); and the processability of the foamable composition is improved, that is, a foam product can be readily fabricated from easily processing the foamable composition. When foam articles are fabricated using the foamable composition, the foam articles exhibit exceptionally improved properties such as bonding strength and other properties as described herein below; while maintaining other mechanical and thermal properties of the foam article to fulfil the requirement(s) of a certain target end-use application.

For example, in some embodiments, the addition of POE/OBC elastomers to the EVA foam improve mechanical properties due to the molecular architecture of these elastomers. The addition of these elastomers improves density reduction, hardness reduction, shrinkage reduction, rebound resilience increase, and recovery increase after compression set.

In some embodiments, the present invention is directed to the foamable composition described above used for making a shaped foam article. In other embodiments, the present invention is directed to a process for producing a shaped foam article from the foamable composition described above. In one preferred embodiment, the shaped foam article is useful in footwear applications wherein the foam article is incorporated into footwear such as shoe parts used in the footwear industry. The foam article of the present invention has a combination of good properties. For example, one surprising property of the present invention is that the foam product exhibits a high level of bond strength without detrimentally affecting the other properties of the foam product.

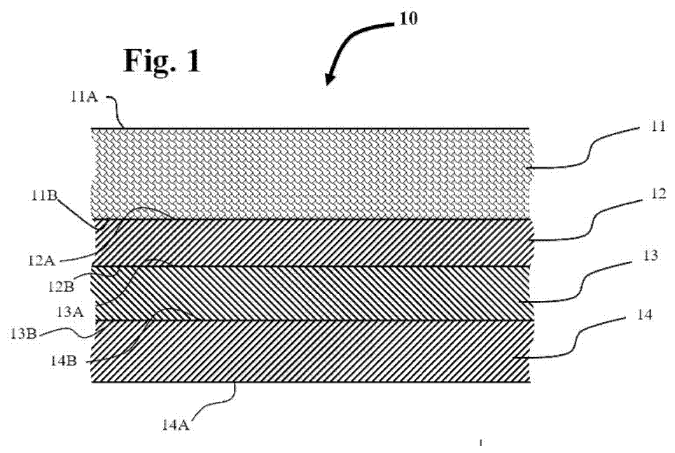

With reference to FIG. 1, there is shown one embodiment of a multi-layer structure, generally indicated by reference numeral 10, which includes several layers, for example a foam layer 11, a primer layer 12, an adhesive layer 13, and a PVC layer 14. The layers 11-14 can be different films and/or substrates of different materials bonded together to form the multilayer structure 10. The multi-layer structure 10 is used as a specimen for performing a bonding test on such specimen (i.e., to test the bonding strength of the foam layer 11 of the multi-layer structure 10). One objective of the present invention is to bond a foam member layer, such as foam layer 11 (a non-polar substrate) to a different substrate, such as a clear PVC layer 14 (a polar layer). In the embodiment shown in FIG. 1, the above objective is achieved, for example, by bonding the foam sample member layer 11, having a top outer side 11A and a bottom inner side 111B, to a clear PVC layer 14, having a top outer side 14A and a bottom inner side 14B. The foam sample member layer 11 is bonded to the PVC layer 14 via a layer of primer 12, having a top side 12A and a bottom side 12B; and a layer of polyurethane-based adhesive 13 having a top side 13A and a bottom side 13B; to form the multi-layer structure 10. The primer layer 12 and the adhesive layer 13 are disposed sandwiched in between the inner most side 11B of the foam member layer 11 and the inner most side 14B of the PVC layer 14. The top side 12A of the primer layer 12 is attached to the bottom inner most side 11B of the foam layer 11; the bottom side 13B is attached to the bottom inner most side 14B of the PVC layer 14; and the bottom side 12B of the primer layer 12 is attached to the top side 13A of the adhesive layer 13 wherein all of the layers 11 to 14 form the multi-layer structure 10; and wherein the sample foam member 11 (the non-polar substrate) is bonded to the clear PVC member 14 (the polar material). The bond strength exhibited between the two layers (the foam layer 11 and PVC layer 14) increased in comparison to known materials without the addition of polar materials to the foam layer 11.

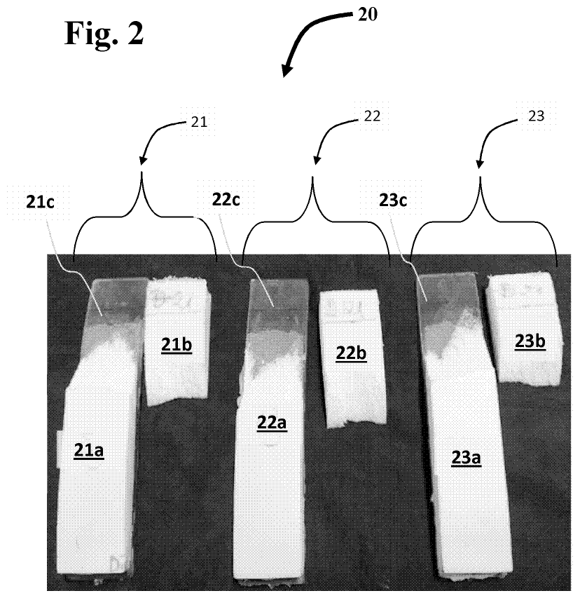

With reference to FIG. 2, there is shown an image, generally indicated by reference numeral 20, of a group of three separate specimens of the present invention, generally indicated by reference numerals 21, 22 and 23, which are specimens produced having essentially the same multilayer structure (foam layer 11, primer layer 12, adhesive layer 13 and PVC layer 14) shown in FIG. 1. Each of the three specimens 21-23, shown in FIG. 2, include two separate torn specimen pieces (21a and 21b; 22a and 22b; and 23a and 23b; for specimens 21, 22 and 23, respectively) formed when the specimens 21-23 rupture (or delaminate) into two pieces after the specimen is subjected to a bonding performance test.

In general, the bond strength testing of the three present invention specimens 21-23 generates a visual occurrence of rupture (or delamination) in the multilayer structure after the bonding test; and the bond strength testing generates (or produces) the two separate torn specimen pieces 21a-23a and 21b-23b of foam layers shown in FIG. 2 for each of the three specimens 21-23 tested. In the top perspective view of FIG. 2, the first specimen pieces 21a-23a are shown with the top outer side (similar to the top outer side 11A of foam layer 11 shown in FIG. 1) of specimen pieces 21a-23a visually facing upward; and the second specimen pieces 21b-23b are shown with the top outer side (similar to the top outer side 11A of foam layer 11 shown in FIG. 1) of specimen pieces 21b-23b visually facing downward. In each of the specimen pieces 21a-23a, a portion of the PVC layer 21c-23c is shown with the bottom inner side of the portion of PVC layer (similar to the bottom inner side 14B of PVC layer 11 shown in FIG. 1) visually facing upward.

With reference to FIG. 2 again, as aforementioned, there is shown the three specimens 21-23 of the present invention in their ruptured form including, for example, (1) a first specimen 21 comprising specimen piece 21a and specimen piece 21b; (2) a second specimen 22 comprising specimen piece 22a and specimen piece 22b; and (3) a third specimen 23 comprising specimen piece 23a and specimen piece 23b. After a bonding test is performed on each specimen, all three specimens 21-23 ruptured at the bonding interfaces of the foam layers specimen pieces 21a, 22a, and 23a and the PVC layers. The foam specimen pieces 21b, 22b, and 23b of the three specimens 21, 22, and 23, respectively tore off or ruptured (and separated) from the foam specimen pieces 21a-23a, respectively. A rupture of the layers in the multilayer structure of the specimens 21-23, as observed visually with the naked eye, occurs after the three specimens 21-23 are subjected to the bonding test. The occurrence of the rupture is a desirable occurrence because such an occurrence shows that bonding between the foam layers (i.e., the combined specimen pieces 21a-23a and specimen pieces 21b-23b before rupture) and PVC layers (see portion 21c-23c of specimen pieces 21-23, respectively) is effective.

The foam layers of all three specimens 21-23 shown in FIG. 2 are produced using substantially the same foamable formulation of the present invention making up the foam layers of the specimens 21-23 and having the multilayer structure 10 shown in FIG. 1. In addition, the other layers (primer layer 12, adhesive layer 13, and PVC layer 14) of the three specimens 21-23 are also made using the same materials for each of the three present invention specimens 21-23. The foamable formulations used to make the foam layers of the specimens 21-23 include, for example, at least 50 phr of elastomer and at least 30 phr of copolymer of ethylene and methyl acrylate.

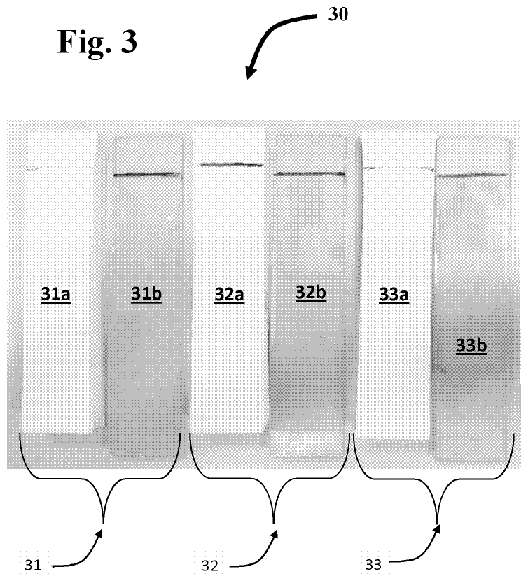

With reference to FIG. 3, there is shown an image, generally indicated by reference numeral 30, of a group of three separate comparative specimens, generally indicated by reference numerals 31, 32 and 33, which are comparative specimens produced having essentially the same multilayer structure (foam layer 11, primer layer 12, adhesive layer 13 and PVC layer 14) shown in FIG. 1. Each of the three specimens 31-33, shown in FIG. 3, include two separate comparative specimen pieces (31a and 31b; 32a and 32b; and 33a and 33b; for specimens 31, 32 and 33, respectively).

In general, the bond strength testing of the three comparative specimens 31-33 does not generate a visual occurrence of rupture (or delamination) in the multilayer structure after the bonding test. Instead, the bond strength testing of the three comparative specimens 31-33 generates (or produces) two separate, non-torn (or non-ruptured or non-delaminated) of intact foam layer specimen pieces 31a-33a and intact PVC layer specimen pieces 31b-33b as shown in FIG. 3 for each of the three specimens 31-33 tested. The two separate specimen pieces 31a-33a and 31b-33b are formed when the specimens 31-33 peel into two separate, non-torn (or non-ruptured or non-delaminated) specimen pieces 31a-33a and 31b-33b after the specimens 31-33 are subjected to a bonding performance test. Therefore, the bond strength testing of the three comparative specimens 31-33 generates a visual occurrence of a peel or separation of foam layers from PVC layers present in the multilayer structures of the three comparative specimens 31-33. In the top perspective view of FIG. 3, there is shown the first specimen pieces 31a-33a with the top side (similar to the top outer side 11A of foam layer 11 shown in FIG. 1) of foam specimen pieces 31a-33a visually facing upward; and the second specimen pieces 31b-33b are shown with the top side (similar to the top outer side 11A of foam layer 11 in FIG. 1) of specimen pieces 31b-33b visually facing downward.

With reference to FIG. 3 again, as aforementioned, there is shown the three comparative specimens 31-33 in their peeled form including, for example, (1) a first specimen 31 comprising specimen piece 31a and piece 31b; (2) a second specimen 32 comprising specimen piece 32a and piece 32b; and (3) a third specimen 33 comprising specimen piece 33a and piece 33b. After a bonding test is performed on each specimen, all three specimens 31-33 separated at the bonding interfaces of the foam layers 31a, 32a, and 33a and the PVC layers 31b, 32b, and 33b, respectively, of the three specimens 31, 32, and 33, respectively. After the three comparative specimens 31-33 have been subjected to bond strength testing, no occurrence of rupture (or delamination) in the layers of the multilayer structure is observed visually with the naked eye. The lack of rupture/delamination of the specimens 31-33 is not desirable because it demonstrates that bonding between the layers of foam specimen pieces 31a-33a and the layers of PVC specimen pieces 31b-33b of the specimens 31-33, respectively, is not effective; particularly, when the layers of foam specimen pieces 31a-33a do not contain a polarity modifier.

The three specimens 31-33 shown in FIG. 3 are comparative examples of foam articles having multilayer structures, such as shown in FIG. 1, which are made from known materials without the addition of polar materials to the foam layers of the comparative specimens 31-33. Accordingly, the three comparative specimens 31-33 shown in FIG. 3 are different from the three present invention specimens 21-23 of FIG. 2. All three specimens 31-33 shown in FIG. 3 have essentially the same multilayer structure as shown in FIG. 1; and all three specimens are produced using substantially the same foamable formulation making up the layers of foam specimen pieces 31a-33a, similar to the foam layer 11 shown in FIG. 1 except that the foamable formulation making up the layers of foam specimen pieces 31a-33a contains at least 50 phr of elastomer, but does not contain at least 30 phr of a copolymer of ethylene and methyl(or butyl) acrylate (polar material).

In one broad embodiment of the present invention, a process for making the foam article includes, for example, using any conventional foam-forming process such as processes and equipment well known to those skilled in the art of producing foams.

In general, the process of manufacturing the foam article of the present invention includes the following general procedure:

In some embodiments, roll milled sheets (or molded plate samples) are first prepared using the general procedure described above. The roll milled sheets are then cut into squares having dimensions of 80 mm×80 mm×2 mm; and the squares are placed inside a pre-heated bun foam mold or “chase”. The mold dimensions can vary depending on the size of the compression molding machine used to cure the samples. In one general embodiment, for example, the mold dimensions can be 100 mm×100 mm×10 mm.

In some embodiments, the surface of the chase is sprayed with a dry lubricant (e.g., a dry polytetrafluoroethane (PTFE) lubricant such as Fluoroglide) to avoid sticking of the foam to the chase during de-molding. The roll milled sheets (or molded plates) are cut into pieces that fit into the lubricated chase and stacked to provide enough material plus a little extra to completely fill the chase after preheating and pressing. A rubber knife is used to cut the sheets. The pieces of the sheets are weighed to ensure sufficient material is added to the chase. The mass of the sample used to fill the chase can be calculated by taking the volume of the chase and multiply by the calculated density of the sheet. The resulting mass plus 10% extra will be enough to completely fill the chase.

The “molding tray” used to support the sample during preheat and curing can be, for example, a smooth flat metal tray with handle grips to hold during transfer between presses. On top of the smooth tray, a thin sheet of metal can be used to make sure the surface of the foam will be smooth. Minimum pressure is applied during this initial preheat to avoid pushing material out of the chase before the material has completely melted.

In some embodiments, the preheating step lasts for 8 min at 110° C. for POE foams; and the preheating step lasts for 8 min at 120° C. for OBC foams. After the preheating step, the pressure applied to the sample is increased to 20 tons for 4 min. The preheating and pressing steps are used to sufficiently eliminate air pockets inside the sample and to sufficiently eliminate air pockets between the stacked layers prior to curing the sample. Omitting the preheating and pressing steps can cause voids to form in the final sample and limit the useful area of the bun foams produced for testing.

After 4 min of applying 20 tons of pressure on the sample, the pressure is released and the tray with the sample is immediately transferred to a cure press. The cure press is operated at 180° C. for 8 min; and a full pressure of 177,932 N on a 5.1 cm ram is applied to the sample. Once the cure time of 8 min has elapsed, the pressure on the sample is released; the platens of the press immediately open; and the foam pops out of the mold but remains in the tray until the foam can be quickly removed from the press.

Some of the advantageous/beneficial properties exhibited by the foam article produced according to the above-described process, can include, for example, improvement in: (1) bonding strength; (2) compression set; (3) shrinkage; (4) hardness; and (5) rebound resilience.

In some embodiments, the bonding strength of the foam article of the present invention is, for example, from 1 N/mm to 5 N/mm in one general embodiment, from 1 N/mm to 3.5 N/mm in another embodiment, and from 1 N/mm to 1.5 N/mm in still another embodiment.

In some embodiments, the compression set of the foam article is, for example, from 15% to 60% in one general embodiment, from 15% to 50% in another embodiment, and from 15% to 40% in still another embodiment.

In some embodiments, the shrinkage of the foam article is, for example, from 0% to 2% in one general embodiment, from 0.2% to 2% in another embodiment, from 0.3% to 1.5% in still another embodiment, and from 0.4% to 1.2% in still another embodiment.

In some embodiments, the hardness of the foam article is, for example, from 25 Shore A to 50 Shore A in one general embodiment, from 25 Shore A to 40 Shore A in another embodiment, and from 25 Shore A to 30 Shore A in still another embodiment.

The rebound resilience of the foam article is, for example, from 40% to 60% in one general embodiment, from 40% to 50% in another embodiment, and from 40% to 45% in still another embodiment.

The foamable composition and the foam product made therefrom as described above can be used, for example, in footwear applications; midsoles applications; insoles applications; casual shoes applications; and mono-block shoes applications.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise, stated all parts and percentages are by weight on a total weight basis.

### Abbreviations and Designations

Various terms, designations, and raw materials used in the Inventive Examples (Inv. Ex.) and the Comparative Examples (Comp. Ex.) are explained as follows:

“ER” stands for expansion ratio.

“Dyn Cset” stands for dynamic compression set.

“Static Cset” stands for static compression set.

### Raw Materials

The ingredients/raw materials used in the Examples are described in Table I as follows:

TABLE I
Ingredients/Raw Materials

| | Brief Description of | |
|---|---|---|
| Ingredient | Ingredient | Supplier |
| ELVAX ™ 460 | Ethylene vinyl-acetate (EVA) | The Dow Chemical |
| | | Company (Dow) |
| INFUSE ™ 9500 | Olefin block copolymer | Dow |
| | (OBC) | |
| ENGAGE ™ 8200 | Polyolefin elastomer (POE) | Dow |
| ELVALOY ™ | Ethylene-methyl acrylate | Dow |
| AC 1330 | copolymer (EMA) | |
| ELVALOY ™ | Ethylene-butyl acrylate | Dow |
| AC 3427 | copolymer (EBA) | |
| Peroxide dicumyl | Crosslinking agent | Arkema |
| Azodicarbonamide | Blowing agent | DONG JIN DONG |
| | | JIN SEMICHEM |
| Zinc oxide (ZnO) | Accelerator | Votorantim |
| Zinc stearate (ZnSt) | Accelerator | Fisher |
| Calcium carbonate | Filler | Imerys Carbonates |
| (CaCO₃) | | |
| Titanium oxide | Filler/Colorant for white | Auriquimica |
| (TiO₂) | color | |

### Foamable Formulations

### General Procedure for Preparing Formulations

An internal mixer such as a Banbury mixer or a Thermo Haake mixer (available from Thermofisher) with tangential rotors is used for mixing the foamable formulation. This type of internal mixer is commonly used in the footwear industry. Also, a kneader mixer type can be used for mixing the formulation. The tangential rotors of the mixer provide the mixing and mixing also occurs between walls of the chamber and the tip of the rotor blades. The following conditions/parameters are used: initial temperature of mixing is 80° C., a capacity of 379 cm³, a filling factor of 70%, and a rotation of 60 rpm. Each formulation is produced in 4 batches to have enough material to produce foam samples for all tests.

An open mill such as a Cope mixer (a two-roll counter-rotating mill, available from Copé, a Brazilian manufacturer of machinery for rubber mixing) is used to homogenize the aforementioned 4 batches of each formulation as well as to produce thin sheets (having a thickness of ˜2 mm). The following conditions/parameters are used: an initial temperature of 90° C., and a rotation of 14 rpm.

A Compound RPA (Rubber Processing Analyzer) is used to measure the effect of blowing agent and peroxide on the cure behavior of a produced compound. The crosslinking properties of the samples are evaluated via rheometric curves, according to the procedure described in ASTM D5289-17; and using the following conditions/parameters: a deformation of +/−0.5° Arc, a frequency of 100 cpm, a temperature of 170° C., and 15 min of testing.

Specimens of foam samples are produced from the foamable formulation samples using a mold with dimensions of 100 mm×100 mm×10 mm. Each specimen is crosslinked by compression molding at a temperature of 170° C. (based on RPA results) for 10 min. A fast-opening press (available from FKL, a Brazilian manufacturer) is used for compression molding. Examples 1-6 and Comparative Examples A-E

Generally, the foam compositions or formulations include the following components: an olefin block copolymer (OBC) such as INFUSE™ 9500, or a polyolefin elastomer (POE) such as ENGAGE™ 8200; an EVA compound such as ELVAX™ 460; an ethylene-methyl acrylate such as FLVALOY™ AC 1330 or an ethylene-butyl acrylate such as FLVALOY™ AC 3427; a crosslinking agent such as peroxide having at least a 99% purity; and a blowing agent such as azodicarbonamide. One or more optional components can be added to the formulation including, for example, an accelerator such as ZnO and/or ZnSt; and a filler such as CaCO₃ and/or TiO₂. The formulations used in the Examples are described in Table II.

The expansion ratio (8R) of the foamable formulations is generally between 150% and 160% in one general embodiment; from 15000 to 155% in another embodiment; and from 155% to 160% in still another embodiment. To obtain other expansion ratios, the ingredients/raw materials levels of the foamable formulations may optionally be adjusted.

TABLE II
Foamable Formulations

| | Comp. | Comp. | Comp. | Comp. | Inv. | Inv. | Comp. | Inv. | Inv. | Inv. | Inv. |
|---|---|---|---|---|---|---|---|---|---|---|---|
| Ingredient | Ex. A | Ex. B | Ex. C | Ex. D | Ex. 1 | Ex. 2 | Ex. E | Ex. 3 | Ex. 4 | Ex. 5 | Ex. 6 |
| ELAVAX ™ | 100 | 85 | 85 | 50 | 35 | 35 | 50 | 35 | 20 | 35 | 20 |
| 460 (phr) | | | | | | | | | | | |
| ENGAGE ™ | | | | 50 | 50 | 50 | | 50 | 50 | | |
| 8200 (phr) | | | | | | | | | | | |
| INFUSE ™ | | | | | | | 50 | | | 50 | 50 |
| 9500 (phr) | | | | | | | | | | | |
| ELVALOY ™ | | 15 | | | 15 | | | 15 | 30 | | |
| AC 3427 (phr) | | | | | | | | | | | |
| ELVALOY ™ | | | 15 | | | 15 | | | | 15 | 30 |
| AC 1330 (phr) | | | | | | | | | | | |
| Peroxide | 1 | 1 | 1 | 1 | 1 | 1 | 1.25 | 1.25 | 1.25 | 1.25 | 1.25 |
| dicumyl (phr) | | | | | | | | | | | |
| Azodicarbon | 2.5 | 2.5 | 2.5 | 2.3 | 2.3 | 2.1 | 2.3 | 2.3 | 2.3 | 2.3 | 2.1 |
| amide (phr) | | | | | | | | | | | |
| ZnO (phr) | 1 | 1 | 1 | 1 | 1 | 1 | 1 | 1 | 1 | 1 | 1 |
| ZnSt (phr) | 1 | 1 | 1 | 1 | 1 | 1 | 1 | 1 | 1 | 1 | 1 |
| CaCO₃(phr) | 5 | 5 | 5 | 5 | 5 | 5 | 5 | 5 | 5 | 5 | 5 |
| TiO₂ (phr) | 0.2 | 0.2 | 0.2 | 0.2 | 0.2 | 0.2 | 0.2 | 0.2 | 0.2 | 0.2 | 0.2 |

### Foam Products

### Examples 7-12 and Comparative Examples F-J

### General Procedure for Preparing Foam Samples

The foamable formulation samples described above are used to produce bun foam samples according to the procedure described ASTM D3182-16. The properties of the resultant foam samples are described in Table III.

TABLE III
Properties of Foam Product

| | Example No.: | | | | | | | | | | |
|---|---|---|---|---|---|---|---|---|---|---|---|
| | Comp. | Comp. | Comp. | Comp. | Inv. | Inv | Comp. | Inv. | Inv. | Inv. | Inv. |
| | Ex. F | Ex. G | Ex. H | Ex. I | Ex. 7 | Ex. 8 | Ex. J | Ex. 9 | Ex. 10 | Ex. 11 | Ex. 12 |
| | Ingredients: | | | | | | | | | | |
| | | | | | | | | EVA/ | EVA/ | EVA/ | EVA/ |
| | | | | | EVA/ | EVA/ | | 9500/ | 9500/ | 9500/ | 9500/ |
| | | EVA/ | EVA/ | EVA/ | 8200/ | 8200/ | EVA/ | 342715 | 342730 | 133015 | 133030 |
| Property | EVA | 3427 | 1330 | 8200 | 3427 | 1330 | 9500 | phr | phr | phr | phr |
| Expansion | 155 | 157 | 158 | 160 | 160 | 156 | 157 | 160 | 159 | 160 | 157 |
| Ratio (%): | | | | | | | | | | | |
| Hardness | 46.4 | 41.2 | 40.3 | 28.3 | 26.7 | 26.4 | 37.6 | 31.3 | 29 | 29 | 27.4 |
| (Shore A): | | | | | | | | | | | |
| Hardness | 59.3 | 55.2 | 51.7 | 42.8 | 41 | 41.3 | 48.7 | 45.6 | 44.3 | 45.1 | 42 |
| (Asker C): | | | | | | | | | | | |
| Static Cset (%): | 49.5 | 56.8 | 63 | 94.6 | 80.4 | 85.9 | 44 | 55.4 | 52.7 | 53.3 | 54.7 |
| Density (g/cc): | 0.219 | 0.210 | 0.202 | 0.177 | 0.176 | 0.189 | 0.208 | 0.183 | 0.185 | 0.187 | 0.223 |
| Shrinkage (%) | 0.45 | 0.35 | 0.5 | 1.35 | 1.15 | 0.7 | 0.65 | 0.7 | 0.85 | 0.95 | 0.95 |
| (≤2%): | | | | | | | | | | | |
| Thickness (mm): | 13.6 | 13.8 | 14.5 | 14.8 | 16 | 14 | 13.9 | 14.3 | 14 | 12.8 | 16.6 |
| Rebound (%) | 40.3 | 40.5 | 42.2 | 45.2 | 49.3 | 50.0 | 46.2 | 45.8 | 47.0 | 48.7 | 49.2 |
| (≥50%): | | | | | | | | | | | |
| Dyn Cset - | 23.4 | 19.6 | 26.8 | 57.2 | 55.7 | 56.2 | 36.4 | 52.8 | 58.2 | 50.5 | 58 |
| Deference after | | | | | | | | | | | |
| 100k cycles (%): | | | | | | | | | | | |
| Dyn Cset - | 18.5 | 15.3 | 21.7 | 44.7 | 40.3 | 40.1 | 17 | 32.3 | 37.8 | 28.2 | 43.4 |
| Deference after | | | | | | | | | | | |
| 24 hr (%): | | | | | | | | | | | |
| Recovery (%): | 4.9 | 4.3 | 5.1 | 12.5 | 15.4 | 16.1 | 19.4 | 20.5 | 20.4 | 22.3 | 14.6 |
| Bond Strength | 2.8 | 2.8 | 3.3 | 1.5 | 1.6 | 1.6 | 0.1 | 1 | 0.9 | 0.9 | 2.7 |
| (N/mm) | | | | | | | | | | | |
| (≥2.5 N/mm): | | | | | | | | | | | |

The foam samples of the Inv. Ex. using ELVALOY™ AC 1330 at a concentration of 30 phr exhibits a good balance of properties plus good bonding strength. For example, besides reaching a desired minimum bond strength of 2.5 N/mm, the sample of Inv. Ex. 12 exhibited a bonding test failure in the form of a rupture of the EVA foam which is desirable in the present invention.

Aged samples (stored at room temperature for 5 months) were tested for bonding for a second time, using same PVC sheets, same primer, same adhesive, following the same procedures described above. As described in Table IV, bond strength results for the foam samples varied in comparison to the first bond strength results described above. In general, it was found that bond strength improves when the bond strength of aged foam samples is measured.

One hypothesis for improved bond strength with aged foams, and not to be limited thereby, is that there were remaining unreacted crosslinked agent and/or blowing agent present in the foam; and, while aging, these unreacted raw materials changed the structure of the foam in a way that improved bond strength.

TABLE IV
Bond Strength and Failure Type for Fresh Foams Versus Aged Foams

| | Example No.: | | | | | | | | | | |
|---|---|---|---|---|---|---|---|---|---|---|---|
| | Comp. | Comp. | Comp. | Comp. | Inv. | Inv. | Comp. | Inv. | Inv. | Inv. | Inv. |
| | Ex. F | Ex. G | Ex. H | Ex. I | Ex. 7 | Ex. 8 | Ex. J | Ex. 9 | Ex. 10 | Ex. 11 | Ex. 12 |
| | Ingredients: | | | | | | | | | | |
| | | | | | | | | EVA/ | EVA/ | EVA/ | EVA/ |
| | | | | | EVA/ | EVA/ | | 9500/ | 9500/ | 9500/ | 9500/ |
| | | EVA/ | EVA/ | EVA/ | 8200/ | 8200/ | EVA/ | 342715 | 342730 | 133015 | 133030 |
| Property | EVA | 3427 | 1330 | 8200 | 3427 | 1330 | 9500 | phr | phr | phr | phr |
| ER⁽¹⁾ (%): | 155 | 157 | 158 | 160 | 160 | 156 | 157 | 160 | 159 | 160 | 157 |
| ΔBS⁽²⁾; 2^{nd} | 1.4 | 1.3 | 1.1 | 1.3 | 0.4 | 2.2 | 1 | −0.1 | 2.7 | 1.1 | −0.4 |
| Rd⁽³⁾ - 1^{st} | | | | | | | | | | | |
| Rd: | | | | | | | | | | | |
| Av. BS⁽⁴⁾; | 2.8 | 2.8 | 3.3 | 1.5 | 1.6 | 1.6 | 0.1 | 1 | 0.9 | 0.9 | 2.7 |
| (1^{st} Rd) | | | | | | | | | | | |
| (N/mm): | | | | | | | | | | | |
| Failure | Adh.⁽⁵⁾ | Rup.⁽⁶⁾ | Rup. | Adh. | Lack | Lack | Lack | Lack | Lack | Lack | Rup. of |
| Types | failure | of | of | failure | of | of | of | of | of | of | EVA |
| (1^{st} Rd): | on | EVA | EVA | on | adh. | adh. | adh. | adh. | adh. | adh. | |
| | EVA | | | EVA | | | | | | | |
| Av. BS (2^{nd} | 4.2 | 4.1 | 4.4 | 2.8 | 2 | 3.8 | 1.1 | 0.9 | 3.6 | 2 | 2.3 |
| Rd) | | | | | | | | | | | |
| (N/mm): | | | | | | | | | | | |
| Failure | Rup. | Rup. | Rup. | Lack | Lack | Lack | Lack | Lack | Rup. | Lack | Slight |
| Types | of | of | of | of | of | of | of | of | of | of | Delam.⁽⁷⁾ |
| (2^{nd} Rd): | EVA | EVA | EVA | Adh.; | Adh. | Adh.; | Adh. | Adh. | EVA; | Adh. | of EVA |
| | | | | Rup. | | Rup. | | | Lack | | |
| | | | | of | | of | | | of | | |
| | | | | EVA | | EVA | | | Adh. | | |

Notes for Table IV:
⁽¹⁾“ER” stands for expansion ratio.
⁽²⁾“ΔBS” stands for difference between bond strengths.
⁽³⁾“Rd” stands for round.
⁽⁴⁾“Ave. BS” stands for average bond strength.
⁽⁵⁾“Adh.” stands for adhesion.
⁽⁶⁾“Rup.” stands for rupture.
⁽⁷⁾“Delam.” stands for delamination.

### Testing Methods

### Expansion Ratio (ER)

The general procedure for measuring the expansion ratio (ER) of a bun foam sample is carried out by measuring the initial length of a bun foam sample and the final length of the bun foam sample. The final length of the foam sample is measured after 2 hr of cooling at room temperature. Then, the ER of the bun foam sample is calculated using the following expression:

$$\text{((final length)-(initial length))/(initial length).}$$

Foam samples that have similar ERs are used for testing because foam samples having similar ERs also have mechanical properties that are comparable to each other on the same basis. ER affects foam density and density is related to many of the foam's physical and mechanical properties, such as hardness, compression set, and rebound. The ER measurement target for the foam samples is in the range of from 150% to 160%.

### Foam Density (With Skin)

Hydrostatic density is measured per the method described in ISO 2781-18, method A. Foam samples to be tested are cut from the bun foams with skin. The bun foam template is weighed to the nearest 0.1 g, and the volume of the bun foam template is determined by measuring length, width, and thickness to the nearest 0.01 cm without removing the skin layer.

### Hardness Asker C

An Asker C hardness measurement is done using a durometer device which measures the indentation hardness of a foam material. The Hardness Asker C of a foam sample is measured using the method described in NBR 14455-15. In this testing method, a standardized indenter is pressed against and into a specimen (a foam sample with skin) to generate vertical penetration of the indenter into the specimen. The indenter is applied on the foam samples with skin during 3 s.

### Hardness Shore A

The Hardness Shore A of a foam sample is determined using the method described in ASTM D2240-15. In this testing method, a standardized indenter is pressed against and into a specimen (a foam sample with skin) to generate vertical penetration of the indenter into the specimen. The indenter is applied on the foam sample with skin during 1 s.

### Static Compression Set

The compression set of a foam sample is measured per the procedure described in ASTM D395-18, method B. Using this testing method, a compression of 25% is applied on the foam sample with skin for 4 hr at a temperature of 70° C. in an oven. The deformation (and consequently recovery) of the foam sample is measured 30 min after removing the sample from the oven.

### Shrinkage

The shrinkage of an expanded foam sample is evaluated according to the procedure established by German Institute PFI (Pruf und Forschungsinstitut Pirmasens e.v.). The dimensions of three specimens of the foam samples with skin are measured before oven aging the samples for 4 hr at 70° C. The dimensions of the specimens are measured again after oven aging the samples for 4 hr at 70° C. and after allowing the samples to cool for 1 hr at 23° C.

### Dynamic Compression Set

Dynamic compression set is measured per the method described in NBR 14739/10.

The remaining deformation of the bun foam sample is measured immediately and 24 hr after 100,000 cycles of compression/release at 23° C. The size of the specimen tested is 30 mm×30 mm×10 mm, the load on the specimen is 400 N (90 lb) maximum load, the disc used is 75 mm in diameter, and the disc has no inclination.

The dynamic compression set method, in one embodiment, is used to quantify the fatigue resistance of a foam product. It has been shown that crosslinked foams containing high levels (e.g., ≥50 phr) of an elastomer used in the foamable formulation of the present invention such as INFUSE™ OBC, continue to recover for several days (e.g., 15 days) after subjecting the foam to testing. In general, a foam made from a foamable formulation of the present invention containing an elastomer such as INFUSE™ OBC that has the benefit of continuing to recover after several days means that a foam product such as a shoe part (e.g., a shoe midsole) made from the composition or formulation of the present invention is advantageously more durable than a foam product made from a foamable formulation without the elastomer of the present invention because the foam of the present invention recovers its original thickness after compression is applied to the foam. For example, after someone runs using shoes having shoe midsoles made from foam of the present invention, the midsoles recover to its original thickness.

### Bond Strength

Adhesion of the foam article to crystal flexible PVC sheets is determined using the procedure described in ABNT NBR 10456/2020. The bonding force is measured in N/mm in the longitudinal and transversal directions. The visual aspect of the bonding failure can be observed with the naked eye as, but not limited to: (1) delamination of the foam from a PVC sheet, (2) detachment of the foam from the PVC sheets, and/or (3) cohesive (foam tear) failure.

Bonding is evaluated between the foam specimen with skin and a crystal PVC sheet. Bonding performance is an important analysis to a shoe manufacturer. For example, if bonding of a midsole to the upper part of a shoe is insufficient, the whole shoe developed fails, even if the other properties of the shoe are achieved. Insufficient bonding is a consequential type of failure because such a failure can occur when a customer is using the shoes.

The target measurements for hardness and compression set (for both static and dynamic) depends on the shoe type; but in general, the lower hardness and compression of the foam, the better; and the higher recovery of the foam, the better.

In some embodiments, a suitable package of primer/adhesive can be included with a foam product in order to provide an acceptable bonding performance of the foam product.

The samples (foam specimens) are conditioned according to Condition A (23° C.±2° C. and 50%±5% relative humidity) for a minimum period of 24 hr, as described in ABNT NBR 10455:2021.

The adhesion process described in the test procedure of ABNT NBR 10456/2020 includes the following steps:
(1) cleaning the foam specimen with special EVA solvent (90SO 270) using a clean cloth;
(2) leaving the foam specimen in an oven at 50° C. for 10 min;
(3) applying, with a clean cloth, the EVA primer (e.g., Kisafix KFPE70SUV) to the specimen;
(4) allowing the EVA primer to dry for 10 min;
(5) cleaning the crystal PVC sheets with acetone;
(6) allowing the sheets to dry for 3 min to 5 min;
(7) applying the PU base adhesive (e.g., Kisafix PVC 180 ST) on EVA and crystal PVC;
(8) leaving the adhesive to dry for 20 min;
(9) reactivating the set at a temperature of between 60° C. and 70° C.; and
(10) pressing the foam specimen for 15 s using rubber plates to assist in providing a compression of 703 kg/m².

According to Ibtec, a laboratory that conducts bond strength testing, there are some general acceptable ranges for bonding strength according to shoe type, for example, as follows:
(1) for protection, sports, children, military shoes: a minimum bonding strength of 6.0 N/mm is acceptable;
(2) for medium request shoes (daily use): a bonding strength of 4.5 N/mm is acceptable;
(3) for dress shoes; high heels; high fashion; light males: a bonding strength of 3.5 N/mm is acceptable; and
(4) for low demand shoes (e.g., sandals; slippers; homemade; child; and baby shoes): a bonding strength of 2.5 N/mm is acceptable.

The above-described numbers are for illustrative purposes and not a rule or an exhaustive list; and the numbers can vary according to each shoe producer and brand owner. In general, some foam manufacturers desire a bond strength of at least 2.5 N/mm which is sufficient for a desirable bonding performance. Some foam manufacturers consider a visual rupture of the EVA foam sample, after subjecting the sample to the bonding test, to be an indication of good bonding strength. For example, if rupture occurs and a bond strength of a foam is measured to be 2 N/mm, some foam manufacturers consider this visual rupture occurrence to be sufficient for manufacturing a desirable foam product for use in footwear applications. However, the aforementioned visual rupture occurrence criteria can vary from one foam manufacturers to another.

### Rebound Resilience

A rebound test method refers to the determination of resilience of a material such as a foam, expressed as percentage resilience or rebound resilience of the material. A Schob Type pendulum rebound tester or device is used to generate the data for this test; and the procedure used for obtaining rebound measurements is described in DIN 53512. Using the pendulum rebound tester, rebound resilience is determined by a freely falling pendulum hammer that is dropped from a given height that impacts a test specimen and imparts to the test specimen a certain amount of energy. A portion of that energy is returned by the specimen to the pendulum and may be measured by the extent to which the pendulum rebounds, whereby the restoring force is determined by gravity. Rebound resilience is the ratio of energy returned to energy applied. In the rebound resilience test, the resilience is established as the ratio of the height of rebound of a pendulum by the pendulum's height of fall.

The pendulum, from the pendulum's initial horizontal position, impacts each specimen six times. The first three impacts serve to mechanically condition the test specimen and the last three impacts serve to establish the specimen's rebound resilience. The median of the last three impact measurements is taken as the result of the specimen's rebound resilience.

### Results Discussion

The data generated and described in Tables I-IV is data that is usually evaluated in Footwear Industry. Some of the properties described above are more important for casual type shoes, while other properties are more important for athletic type shoes midsoles. Also, the target for each property of the foam product produced with the foamable composition of the present invention varies according to the application in which the foam product is used; and the target for each property of the foam product varies according to the shoe manufacturer/show brand owner. One objective of the present invention is directed to improving the bonding strength of foam products when bonding the foam product to another different polar substrate such as PVC. However, it would be undesirable if the addition of the ethylene-methyl acrylate copolymer to the foamable formulation improves the bonding strength of the foam made from the formulation but decreases other foam properties. Therefore, improving the bonding strength of the foam made from the formulation, while maintaining the other foam properties and/or generating a balance of all the above-described foam properties is highly desirable.

The sample containing ELVAX™ 460, 50 phr INFUSE™ 9500, and 30 phr ELVALOY™ AC 1330 advantageously exhibited a satisfactory bond strength (e.g., >2.5 N/mm) and showed a complete delamination of the foam. This formulation sample improves bonding, and achieves satisfactory results in terms of density, shrinkage, rebound, and hardness. The compression set property of the formulation sample decreased slightly in comparison to the sample containing only ELVAX™ 460 and 50 phr INFUSE™ 9500. However, a higher performance in terms of compression set is achieved (which means a lower compression set is achieved) by adjusting slightly the level of peroxide in the formulation. Using this adjustment to the formulation including ELVAX™ 460, 50 phr INFUSE™ 9500, and 30 phr ELVALOY™ AC 1330, an acceptable compression set is achieved by the formulation; and the formulation may be used in many more footwear applications.

What is claimed is:

1. A foamable composition comprising:
(a) at least one elastomer selected from the group consisting of: (i) ethylene/alpha-olefin multi-block interpolymers; (ii) ethylene/alpha-olefin elastomers; and (iii) combinations thereof;
(b) at least one ethylene vinyl acetate;
(c) at least one polarity modifier selected from the group consisting of: (i) ethylene-alkyl acrylate copolymers, (ii) ethylene-alkyl methacrylate copolymers; and (iii) combinations thereof;
(d) at least one crosslinking agent; and
(e) at least one blowing agent.

2. The foamable composition of claim 1, wherein the at least one elastomer, component (a), is selected from the group consisting of: (i) ethylene/alpha-olefin multi-block interpolymers having a density of 0.850 g/cc to 0.890 g/cc and a melt index, I₂, of 0.5 g/10 min to 50 g/10 min; (ii) ethylene/alpha-olefin elastomers having a density of 0.850 g/cc to 0.890 g/cc and a melt index, I₂ of 0.5 g/10 min to 50 g/10 min; and (iii) combinations thereof;
wherein the at least one ethylene vinyl acetate, component (b), is an ethylene vinyl acetate having a vinyl acetate level of from 18 weight percent to 35 weight percent;
wherein the at least one polarity modifier, component (c), is selected from the group consisting of: (i) ethylene-alkyl acrylate copolymers, (ii) ethylene-alkyl methacrylate copolymers; and (iii) combinations thereof;
wherein the at least one crosslinking agent, component (d), is selected from the group consisting of dicumyl peroxide; and mixtures of dicumyl peroxide with other crosslinking agents; and
wherein the at least one blowing agent, component (e), is selected from the group consisting of azodicarbonamide; and mixtures of azodicarbonamide with other blowing agents and/or physical foaming agents.

3. The foamable composition of claim 1, wherein the composition further includes (f) one or more compounds selected from the group consisting of: (i) accelerators; (ii) fillers; and (iii) combinations thereof.

4. The foamable composition of claim 3, wherein the accelerator is ZnO, ZnSt or mixtures thereof; and wherein the filler is CaCO₃, TiO₂, or mixtures thereof.

5. The foamable composition of claim 1, wherein the ethylene/alpha-olefin multi-block interpolymers have one or more of the following characteristics: a density of from 0.850 g/cc to 0.890 g/cc and a melt index, I₂, of 0.5 g/10 min to 50 g/10 min.

6. The foamable composition of claim 1, wherein the concentration of the elastomer in the composition is greater than or equal to 45 weight percent; wherein the concentration of the ethylene vinyl acetate in the composition is from 10 weight percent to 35 weight percent; wherein the concentration of the at least one polarity modifier in the composition is from 10 weight percent to 40 weight percent; wherein the concentration of the crosslinking agent in the composition is greater than or equal to 1 weight percent; and wherein the concentration of the blowing agent in the composition is greater than or equal to 1 weight percent; wherein the above concentrations are based on the total components in the foamable composition.

7. A process for producing a foamable composition comprising admixing:
(a) at least one elastomer selected from the group consisting of: (i) ethylene/alpha-olefin multi-block interpolymers; (ii) ethylene/alpha-olefin elastomers; and (iii) combinations thereof;
(b) at least one ethylene vinyl acetate;
(c) at least one polarity modifier selected from the group consisting of: (i) ethylene-alkyl acrylate copolymers, (ii) ethylene-alkyl methacrylate copolymers; and (iii) combinations thereof;
(d) at least one crosslinking agent; and
(e) at least one blowing agent.

8. A foam article formed from the composition of any of the previous claims.

9. The foam article of claim 8, wherein the foam article exhibits one or more of the following properties: a bonding strength of from 1 N/mm to 5 N/mm; a compression set of from 15 percent to 60 percent; a shrinkage of from 0 percent to 2 percent; a hardness of from 25 Shore A to 50 Shore A; and a rebound resilience of from 40 percent to 60 percent.

10. The foam article of claim 8, wherein the foam article is a shoe part.

11. A process for manufacturing a foam article, the process comprising the steps of:
(I) providing components: (a) at least one elastomer selected from the group consisting of: (i) ethylene/alpha-olefin multi-block interpolymers; (ii) ethylene/alpha-olefin elastomers; and (iii) combinations thereof; (b) at least one ethylene vinyl acetate; (c) at least one polarity modifier selected from the group consisting of: (i) ethylene-alkyl acrylate copolymers, (ii) ethylene-alkyl methacrylate copolymers; and (iii) combinations thereof; (d) at least one crosslinking agent; and (e) at least one blowing agent;
(II) mixing the components (a) to (e) of step (I) at a temperature of from 120° C. to 130° C. to form a foamable composition; and
(III) forming at least one foam article from the foamable composition of step (II); wherein the foam article exhibits one or more of the following properties: a bonding strength of from 1 N/mm to 5 N/mm; a compression set of from 15 percent to 60 percent; a shrinkage of from 0.001 percent to 2 percent; a hardness of from 25 Shore A to 50 Shore A; and a rebound resilience of from 40 percent to 60 percent.

12. The process of claim 11, wherein the foam article is at least one foam layer included in a multilayer structure; wherein the foam layer is bonded to a polar material layer; and wherein a visual delamination of the foam layer occurs upon subjecting the multilayer structure to a bonding strength test.
